(19) United States
(12) Patent Application Publication
(10) Pub. No.: US 2008/0264124 A1
(43) Pub. Date: Oct. 30, 2008

(54) Lock core assembly with multiple burglarproof effects

(76) Inventors: Hsiu-Chuan Wu, Pingtung Hsien (TW); I-Chien Hsin, Banciao City (TW)

Correspondence Address: POSZ LAW GROUP, PLC, 12040 SOUTH LAKES DRIVE, SUITE 101, RESTON, VA, 20191, US

(21) Appl. No.: 11/790,111

(22) Filed: Apr. 24, 2007

(51) Int. Cl. E05B 9/04

(52) U.S. Cl. 70/371

(57) ABSTRACT

A lock core assembly has a lock shell, a lock core mounted rotatably in the lock shell, multiple pin assemblies and an arrestor. Multiple mounting chambers are formed between the lock core and the lock shell. The pin assemblies are mounted respectively in the mounting chambers and each have an upper pin situated at an interface between the lock core and the lock shell to prevent a rotation of the lock core and a lower pin with an annular groove. The lock shell has a retaining cavity formed inside. The lock core has a mounting recess communicating with the mounting chambers and aligning with the retaining cavity. The arrestor is mounted slidably in the mounting recess. Without inserting a right key into the lock core, the arrestor is held in the retaining cavity to prevent the lock core from rotating to provide an improved burglarproof effect.

### BACKGROUND OF THE INVENTION

1. Field of the Invention

The present invention relates to a lock core assembly, and more particularly to a lock core assembly that has multiple locking manners to provide multiple burglarproof effects.

2. Description of Related Art

With reference to FIGS. 11 and 12, a conventional lock core assembly in accordance with the prior art has a lock shell (60), a lock core (61) and multiple pin assemblies (62). The lock shell (60) has an outer wall, a receiving hole, multiple upper pin chambers and a lid (63). The receiving hole is formed longitudinally through the lock shell (60) and has an inner wall. The upper pin chambers are formed radially through the outer wall of the lock shell (60), are arranged in a longitudinal line and communicate with the receiving hole. The lid (63) is mounted detachably on the outer wall of the lock shell (60) and covers the upper pin chambers. The lock core (61) is mounted rotatably in the receiving hole in the lock shell (60) and has an outer wall, a key hole and multiple lower pin chambers. The key hole is formed longitudinally in the lock core (61). The lower pin chambers are formed radially through the outer wall of the lock core (61), communicate with the key hole and respectively align and interconnect with the upper pin chambers to individually form a mounting chamber (64).

The pin assemblies (62) are respectively mounted in the mounting chambers (64) and each of the pin assemblies (62) has a lower pin (622), an upper pin (621) and a spring. The lower pin (622) is mounted slidably in the lower pin chamber in the mounting chamber (64) and has a bottom end. The upper pin (621) is mounted slidably in the upper pin chamber in the mounting chamber (64) and abuts the lower pin (622). The spring is mounted in the upper pin chamber between the upper pin (621) and the lid (63) to press the upper pin (621) to abut the lower pin (622).

The lower pins (622) do not have uniform lengths, so that interfaces between the mutually abutted upper pins (621) and lower pins (622) do not locate at an identical level in a default situation, and each of the lower pins (622) is situated right at an interface between the inner wall of the receiving hole in the lock shell (60) and the outer wall of the lock core (61) to prevent a relative rotation between the lock shell (60) and the lock core (61) to achieve a burglarproof effect for the lock core assembly.

A user can insert a right key into the key hole in the lock core (61) to position the bottom ends of the lower pins (622) individually at a proper level to align the interface between the upper pin (621) and the lower pin (622) of each pin assembly (62) with the interface between the inner wall of the receiving hole in the lock shell (60) and the outer wall of the lock core (61), and then turns the key to rotate the lock core (61) relative to the lock shell (60) to unlock the lock core assembly.

However, a burglar may try to use a special tool to vibrate or knock the lock core assembly to bounce the upper pins (621) from the lower pins (622) to transiently form a gap between the upper pin (621) and the lower pin (622) of each pin assembly (62). When the gap between the upper pin (621) and the lower pin (622) of each pin assembly simultaneously aligns with the interface between the inner wall of the receiving hole in the lock shell (60) and the outer wall of the lock core (61), the burglar can immediately turn the lock core (61) relative to the lock shell (60) to unlock the lock core assembly. Therefore, the conventional lock core assembly does not have an acceptable and reliable burglarproof effect.

### SUMMARY OF THE INVENTION

The primary objective of the present invention is to provide a lock core assembly to mitigate or obviate the aforementioned problems of the conventional lock core assembly.

The lock core assembly in accordance with the present invention has a lock shell, a lock core mounted rotatably in the lock shell, multiple pin assemblies and an arrestor. Multiple mounting chambers are formed between the lock core and the lock shell. The pin assemblies are mounted respectively in the mounting chambers and each have an upper pin situated at an interface between the lock core and the lock shell to prevent the lock core from being rotated by a burglar without a right key and a lower pin with an annular groove. The lock shell has a retaining cavity formed inside. The lock core has a mounting recess communicating with the mounting chambers and aligning with the retaining cavity. The arrestor is mounted slidably in the mounting recess to alternatively insert into the retaining cavity or the annular groove in each lower pin to allow or prevent a rotation of the lock core.

Without inserting the right key into the lock core, the arrestor is unable to insert into the annular groove and inserts into the retaining cavity so that a relative rotation between the lock and lock shell is prevented to provide an improved burglarproof effect.

Other objectives, advantages and novel features of the invention will become more apparent from the following detailed description when taken in conjunction with the accompanying drawings.

### BRIEF DESCRIPTION OF THE DRAWINGS

FIG. 1 is a front view in partial section of a first embodiment of a lock core assembly in accordance with the present invention;

FIG. 2 is a side view in partial section of the lock core assembly in FIG. 1;

FIG. 3 is a side view in partial section of the lock core assembly in FIG. 1 with a right key inserted into a lock core of the lock core assembly;

FIG. 4 is a front view in partial section of the lock core assembly along line 4-4 in FIG. 3 with a right key inserted into the lock core;

FIG. 5 is an operational front view in partial section of the lock core assembly in FIG. 4 with the lock core being turned;

FIG. 6 is a front view in partial section of a second embodiment of a lock core assembly in accordance with the present invention;

FIG. 7 is a side view in partial section of the lock core assembly in FIG. 6;

FIG. 8 is a side view in partial section of the lock core assembly in FIG. 6 with a right key inserted into a lock core of the lock core assembly;

FIG. 9 is a front view in partial section of the lock core assembly along line 9-9 in FIG. 8 with a right key inserted into the lock core;

FIG. 10 is an operational front view in partial section of the lock core assembly in FIG. 8 with the lock core being turned;

FIG. 11 is a side view in partial section of a conventional lock core assembly in accordance with the prior art; and

FIG. 12 is a front view in partial section of the lock core assembly in FIG. 11.

### DETAILED DESCRIPTION OF THE PREFERRED EMBODIMENT

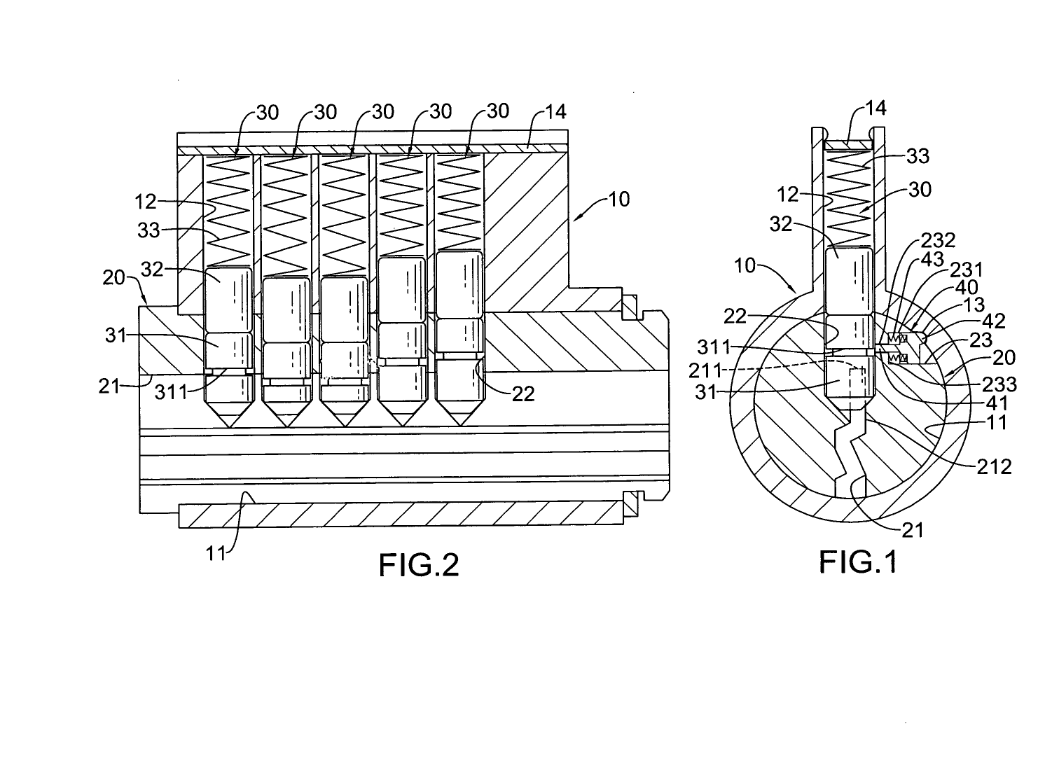

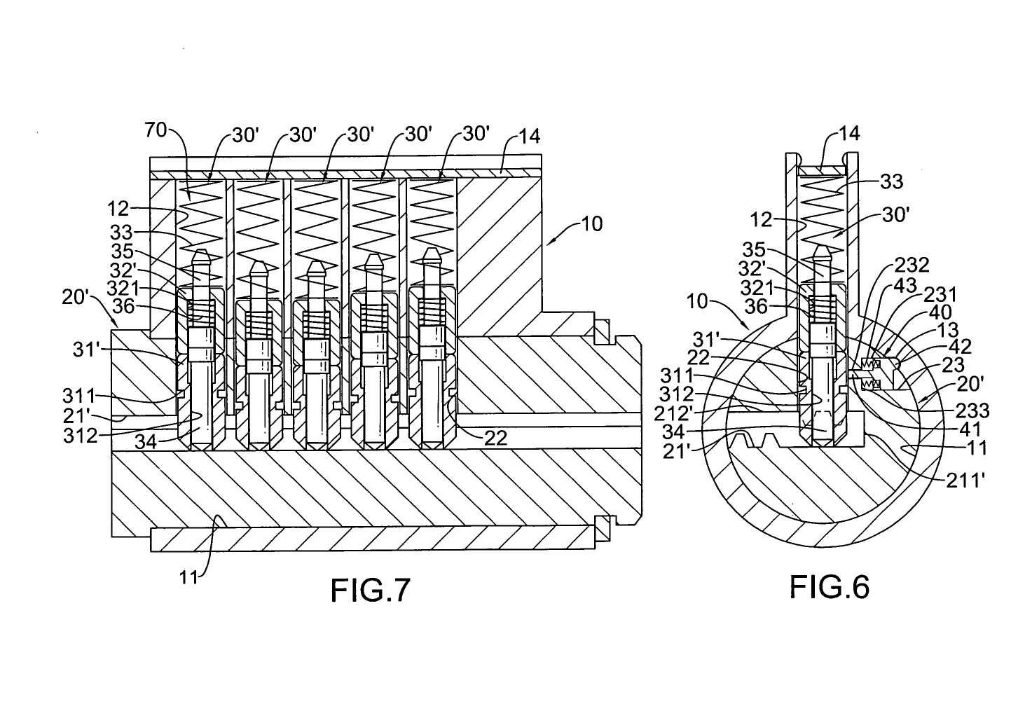

With reference to FIGS. 1, 2, 6 and 7, a lock core assembly in accordance with the present invention comprises a lock shell (10), a lock core (20, 20′), multiple pin assemblies (30, 30′), an arrestor (40) and a positioning resilient element (43).

The lock shell (10) has an outer wall, a receiving hole (11), multiple upper pin chambers (12), a retaining cavity (13) and a lid (14). The receiving hole (11) is formed longitudinally through the lock shell (10) and has an inner wall. The upper pin chambers (12) are formed radially in the lock shell (10), are arranged in a longitudinal line, communicate with the receiving hole (11) and may be formed through the outer wall of the lock shell (10). The retaining cavity (13) is formed longitudinally in the inner wall of the receiving hole (11) and may have a curved bottom. The lid (14) is mounted detachably on the outer wall of the lock shell (10) and covers the upper pin chambers (12).

The lock core (20, 20′) is mounted rotatably in the receiving hole (11) in the lock shell (10) and has an outer wall, a key hole (21, 21′), multiple lower pin chambers (22) and a mounting recess (23). The key hole (21, 21′) is formed longitudinally in the lock core (20, 20′) and has opposite narrow sides (211, 211′) and opposite broad sides (212, 212′). The lower pin chambers (22) are formed radially through the outer wall of the lock core (20, 20′), communicate with the key hole (21, 21′) and may communicate with the narrow side (211) of the key hole (21) or the broad side (212′) of the key hole (21′). The lower pin chambers (22) respectively align and interconnect with the upper pin chambers (12) to individually form a mounting chamber (70).

The mounting recess (23) is formed longitudinally in the outer wall of the lock core (20, 20′), laterally communicates with the lower pin chambers (22), aligns with the retaining cavity (13) in the lock shell (10) in a default situation and may have a narrow end (232), a broad end (231) and an end face (233). The narrow end (232) laterally communicates with the lower pin chambers (22). The broad end (231) communicates with the outer wall of the lock core (20, 20′). The end face (233) is formed between the narrow end (232) and the broad end (231) of the mounting recess (23).

The pin assemblies (30, 30′) are respectively mounted in the mounting chambers (70), each have a lower pin (31, 31′), an upper pin (32, 32′), a first resilient element (33), an optional lower needle (34), an optional upper needle (35) and an optional second resilient element (36) and may be implemented in several way. The lower pin (31, 31′) is mounted slidably in the lower pin chamber (22) in the mounting chamber (64) and has a bottom end and an optional needle hole (312). The needle hole (312) is formed axially through the lower pin (31′).

The upper pin (32, 32′) is mounted slidably in the upper pin chamber (12) in the mounting chamber (70), abuts the lower pin (31, 31′) and has an optional needle hole (321). The needle hole (321) is formed axially through the upper pin (32′) and aligns with the needle hole (312) in the lower pin (32′).

The first resilient element (33) is mounted in the upper pin chamber (12) in the mounting chamber (70) to press the upper pin (32, 32′) to abut the lower pin (31, 31′) and may be mounted between the upper pin (32, 32′) and the lid (14). The first resilient element (33) may be a spring.

The lower pins (31, 31′) do not have uniform lengths. Thus, in the default situation, interfaces between the mutually abutted upper pins (32, 32′) and lower pins (31, 31′) are unable to locate at an identical level, and each lower pin (31, 31′) is situated right at an interface between the inner wall of the receiving hole (11) and the outer wall of the lock core (20, 20′) to prevent the lock core (20, 20′) from rotation relative to the lock shell (10) to provide a first burglarproof manner for the lock core assembly.

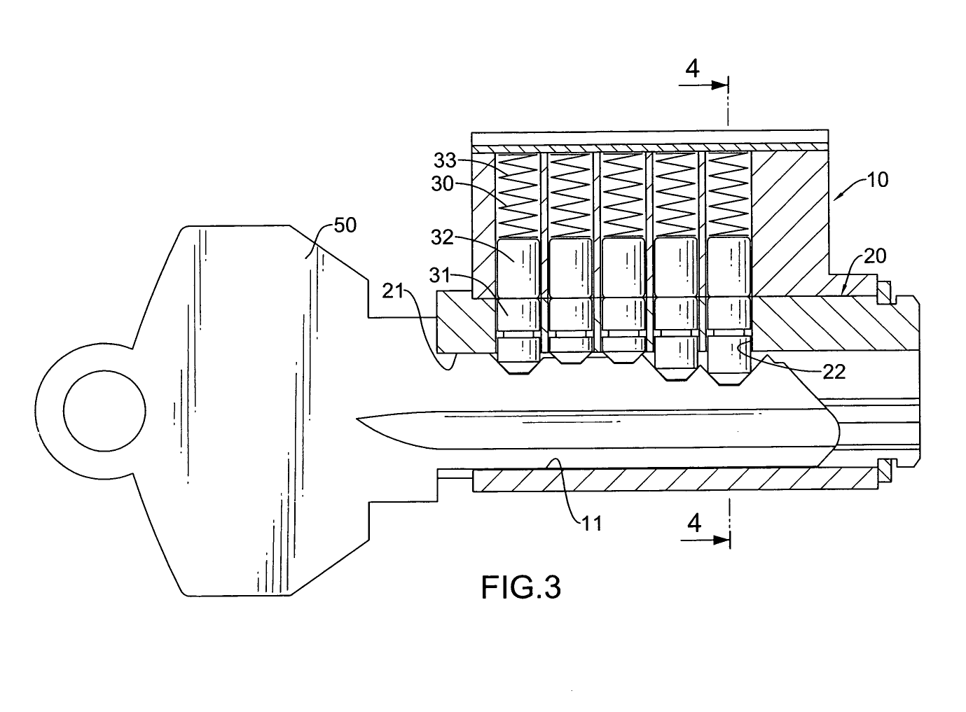

With further reference to FIGS. 3-5 and 8-10, a user can insert a right key (50, 50′) into the key hole (21, 21′) in the lock core (20, 20′) to lift up the pin assemblies (30, 30′) and aligns the interfaces between the mutually abutted upper pins (32, 32′) and lower pins (31, 31′) with the interface between inner wall of the receiving hole (11) and the outer wall of the lock core (20, 20′), and then turns the lock core (20, 20′) relative to the lock shell (10) to unlock the lock core assembly. The lower needle (34) is mounted slidably in the needle hole (312) in the lower pin (31′). The upper needle (35) is mounted slidably in the needle hole (321) in the upper pin (32′) and abuts the lower needle (34). The lower needles (34) do not have uniform length, so that interfaces between the mutually abutted upper needles (35) and lower needles (34) are unable to align simultaneously with the interface between the between the inner wall of the receiving hole (11) and the outer wall of the lock core (20′).

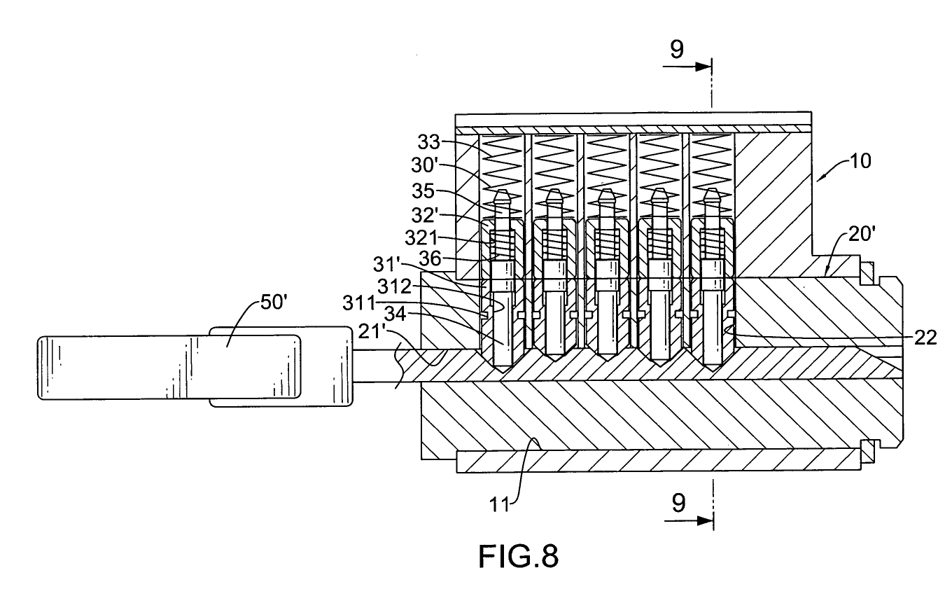

With further reference to FIGS. 8-10, to unlock the lock core assembly, the user has to insert the right key (51′) to lift up the pin assemblies (30′) to align the interfaces between the mutually abutted upper pins (32′) and lower pins (31′) and the interfaces between the mutually abutted upper needles (35) and lower needles (34) simultaneously with the interface between the inner wall of the receiving hole (11) and the outer wall of the lock core (20′), and then turns the lock core (20′) relative to the lock shell (10).

Therefore, a burglar without the right key (50′) is extremely difficult to position the upper pins (32′), the lower pins (31′), the upper needles (35) and the lower needles (34) simultaneously at right positions to unlock the lock core assembly, even using a special tool to vibrate or knock the lock core assembly.

The second resilient element (36) is mounted in the needle hole (321) in the upper pin (32′) to press the upper needle (35) to abut the lower needle (34) and may be a spring. The mutually abutted upper needles (35) and lower needles (34) provide a second burglarproof manner for the lock core assembly.

Wherein, the lower pins (31, 31′) include at least one characteristic lower pin (31, 31′). Each of the at least one characteristic lower pin (31, 31′) has an outer wall and an annular groove (311). The annular groove (311) is formed in the outer wall of the characteristic lower pin (31, 31′). In a preferable implementation of the pin assemblies (30, 30′), the lower pins (31, 31′) include multiple characteristic lower pins (31, 31′) and the annular grooves (311) in the characteristic lower pins (31, 31′) locate at different levels. When the right key (50, 50′) is inserted into the key hole (21, 21′), the annular groove (311) in each of the at least one characteristic lower pin (31, 31′) simultaneously aligns with the narrow end (232) of the mounting recess (23).

The arrestor (40) is mounted slidably in the mounting recess (23) in the lock core (20), has a retaining protrusion (42) and at least one latch (41) and may be implemented in several ways. The retaining protrusion (42) is formed on and protrudes outward from the arrestor (40) and is inserted into the retaining cavity (13) in the lock shell (10) in the default situation. The retain protrusion (42) may have a curved end face corresponding to the curved bottom of the retaining cavity (13). The at least one latch (41) is formed on and protrudes from the arrestor (40) and is respectively adjacent to the at least one characteristic lower pin (31, 31′). The at least one latch (41) may be mounted in the narrow end (232) of the mounting recess (23). In a preferable implementation of the arrestor (40), the arrestor (40) has multiple latches (41) respectively adjacent to the outer walls of the characteristic lower pins (31, 31′).

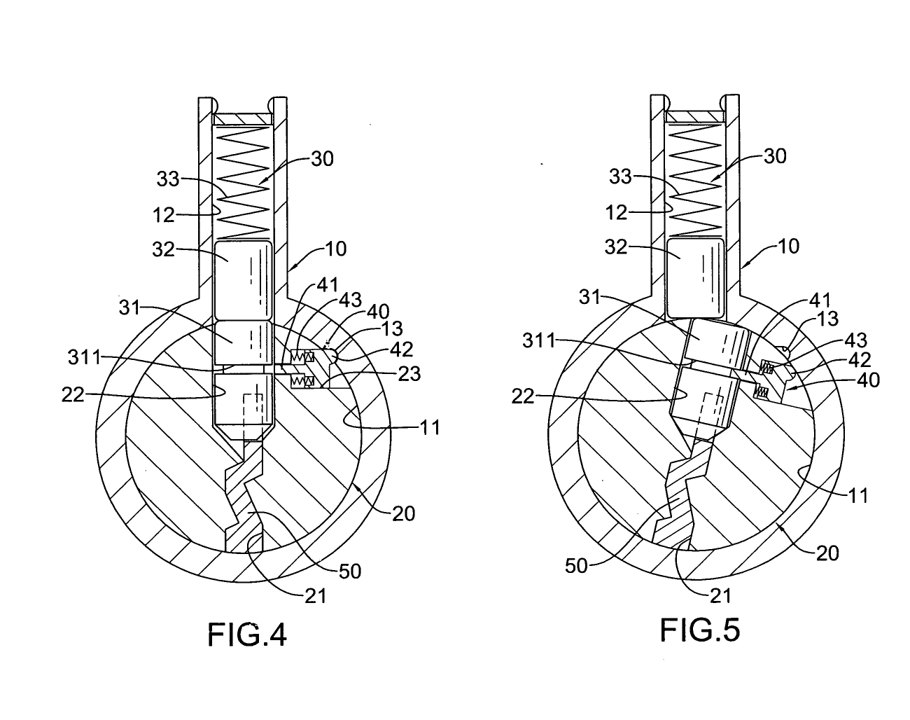

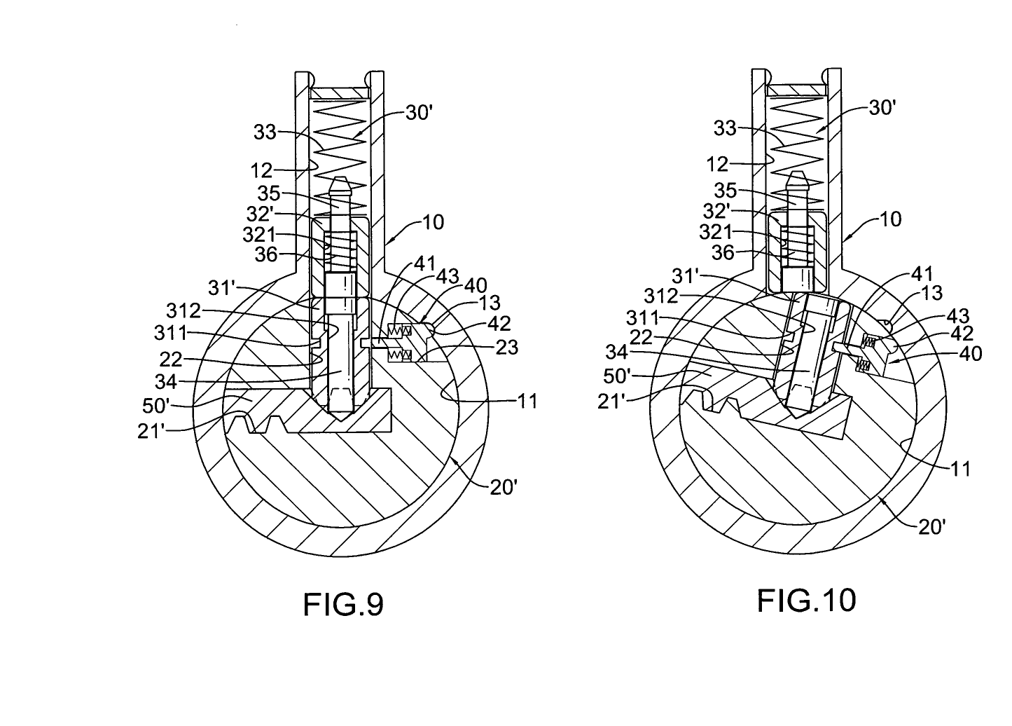

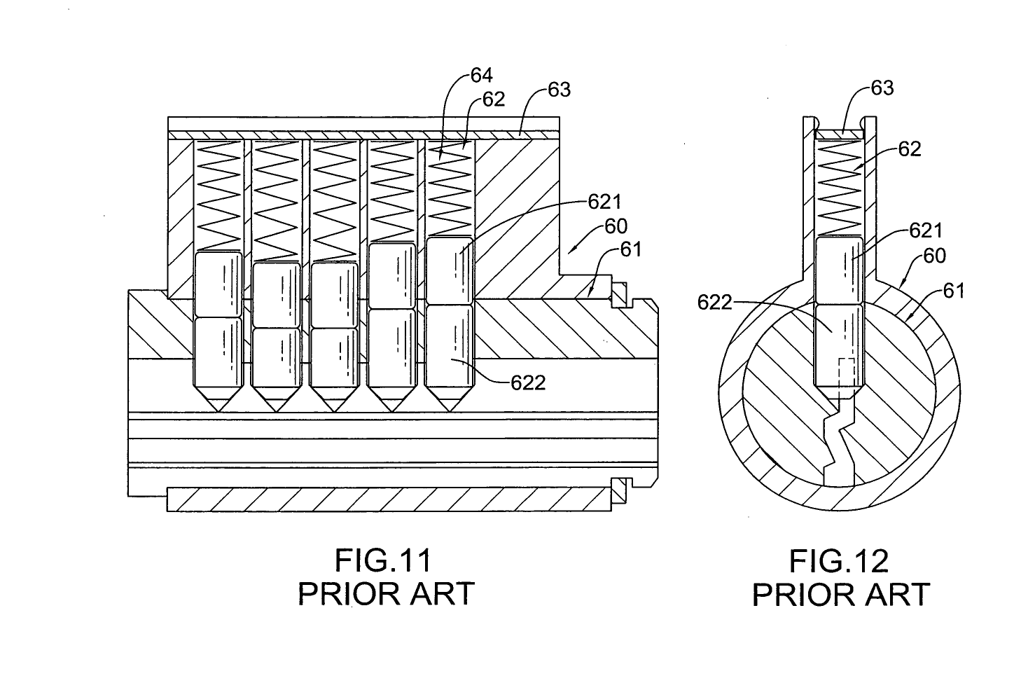

With further reference to FIGS. 4 and 9, without a right key (50, 50′) inserted in the key hole (11, 11′), the annular groove (311) in each of the at least one characteristic lower pin (31, 31′) is offset relative to the narrow end (232) of the mounting recess (23). So, the at least one latch (41) can not individually insert into the annular groove (311) in each of the characteristic lower pin (31, 31′), and this holds the retaining protrusion (42) securely in the retaining cavity (13) to prevent a relative rotation between the lock core (20, 20′) and the lock shell (10) to provide a third burglarproof effect for the lock core assembly.

With further reference to FIGS. 5 and 10, the user can insert the right key (50, 50′) into the key hole (21, 21′) to align the annular groove (311) in each of the at least one characteristic lower pin (31, 31′) simultaneously with the narrow end (232) of the mounting recess (23) for receiving the at least one latch (41) of the arrestor (40), and then the lock core (20, 20′) can be turned relative to the lock shell (10) to impel the retaining protrusion (42) of the arrestor (40) out of the retaining cavity (13) to unlock the lock core assembly.

The positioning resilient element (43) is mounted in the mounting recess (23) in the lock core (20, 20′) to press the arrestor (40) outward and may be mounted against the end face of the mounting recess (23) in the lock core (20, 20′).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lock core assembly comprising
a lock shell having
an outer wall;
a receiving hole formed longitudinally through the lock shell and having an inner wall;
multiple upper pin chambers formed radially in the lock shell, arranged in a longitudinal line and communicating with the receiving hole; and
a retaining cavity formed longitudinally in the inner wall of the receiving hole;
a lock core mounted rotatably in the receiving hole in the lock shell and having
an outer wall;
a key hole formed longitudinally in the lock core;
multiple lower pin chambers formed radially through the outer wall of the lock core, communicating with the key hole and respectively aligning and interconnecting with the upper pin chambers to individually form a mounting chamber; and
a mounting recess formed longitudinally in the outer wall of the lock core, laterally communicating with the lower pin chambers and aligning with the retaining cavity in the lock shell in a default situation;
multiple pin assemblies respectively mounted in the mounting chambers, and each pin assembly having
a lower pin mounted slidably in the lower pin chamber in a corresponding mounting chamber;
an upper pin mounted slidably in the upper pin chamber in the corresponding mounting chamber and abutting the lower pin; and
a first resilient element mounted in the upper pin chamber in the corresponding mounting chamber to press the upper pin to abut the lower pin;
wherein the lower pins include at least one characteristic lower pin, and each one of the at least one characteristic lower pin has
an outer wall; and
an annular groove formed in the outer wall of the characteristic lower pin;
an arrestor mounted slidably in the mounting recess in the lock core and having
a retaining protrusion formed on and protruding outward from the arrestor and inserted into the retaining cavity in the lock shell in the default situation; and
at least one latch formed on and protruding from the arrestor and respectively adjacent to the at least one characteristic lower pin; and
a positioning resilient element mounted in the mounting recess in the lock core to press the arrestor outward.

2. The lock core assembly as claimed in claim 1, wherein
the lower pins include multiple characteristic lower pins and the annular grooves in the characteristic lower pins locate at different levels; and
the arrestor has multiple latches respectively adjacent to the outer walls of the characteristic lower pins.

3. The lock core assembly as claimed in claim 1, wherein
the mounting recess have
a narrow end laterally communicating with the lower pin chambers;
a broad end communicating with the outer wall of the lock core; and
an end face formed between the narrow end and the broad end of the mounting recess;
the at least one latch of the arrestor is mounted in the narrow end of the mounting recess; and
the positioning resilient element is mounted against the end face of the mounting recess in the lock core.

4. The lock core assembly as claimed in claim 2, wherein
the mounting recess have
a narrow end laterally communicating with the lower pin chambers;
a broad end communicating with the outer wall of the lock core; and
an end face formed between the narrow end and the broad end of the mounting recess;
the latches of the arrestor are mounted in the narrow end of the mounting recess; and
the positioning resilient element is mounted against the end face of the mounting recess in the lock core.

5. The lock core assembly as claimed in claim 1, wherein
the retaining cavity in the lock shell has a curved bottom; and
the retaining protrusion of the arrestor has a curved end face corresponding to the curved bottom of the retaining cavity.

6. The lock core assembly as claimed in claim 1, wherein
the lower pin of each pin assembly further has a needle hole formed axially through the lower pin;
the upper pin of each pin assembly further has a needle hole formed axially through the upper pin and aligning with the needle hole in a corresponding lower pin; and
each pin assembly further has
a lower needle mounted slidably in the needle hole in the lower pin of the pin assembly; and
an upper needle mounted slidably in the needle hole in the upper pin of the assembly and abutting the lower needle.

7. The lock core assembly as claimed in claim 6, wherein each pin assembly further has a second resilient element mounted in the needle hole in the upper pin of the pin assembly to press the upper needle of the pin assembly to abut the lower needle of the pin assembly.

8. The lock core assembly as claimed in claim 1, wherein
the upper pin chambers are formed through the outer wall of the lock shell;
the lock shell further has a lid mounted detachably on the outer wall of the lock shell and covering the upper pin chambers; and
the first resilient element of each pin assembly is mounted between the upper pin of the pin assembly and the lid.
